(19) United States
(12) Patent Application Publication
(10) Pub. No.: US 2007/0194290 A1
(43) Pub. Date: Aug. 23, 2007

(54) DEVICE TO ENABLE ROPE PULLING FUNCTIONALITY USING A ROTATIONAL POWER SOURCE

(75) Inventors: Timothy Fofonoff, Cambridge, MA (US); Nathan Ball, Boston, MA (US); Bryan Schmid, Boston, MA (US); Daniel Walker, Cambridge, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Atlas Devices LLC, Cambridge, MA (US)

(21) Appl. No.: 11/679,387

(22) Filed: Feb. 27, 2007

Related U.S. Application Data
(63) Continuation-in-part of application No. 11/376,721, filed on Mar. 15, 2006.
(60) Provisional application No. 60/673,212, filed on Apr. 20, 2005.
(60) Provisional application No. 60/717,343, filed on Sep. 15, 2005.
(60) Provisional application No. 60/778,031, filed on Mar. 1, 2006.

(51) Int. Cl. B66D 1/36

(52) U.S. Cl. 254/325; 254/371

(57) ABSTRACT

A device capable of pulling an object (e.g., a person) by or up a tensioning member (e.g., a rope) is provided. The device can be configured to mate to any location of the tensioning member, and subsequently interface with a rotational power source (such a mechanical drill). Once interfaced, an output of the rotational energy source can be rotationally coupled to a rotating drum of the device wherein the drum is in communication with the tensioning member. With the addition of power, the drum(s) can pull the tensioning member through the device and allow for a continuous force to be applied to an object attached to the device or attached to the tensioning member. The use of such a convenient and low-cost power source allows for an economic, portable, and simple to use device capable of lifting and/or pulling heavy loads.

### FEDERALLY SPONSORED RESEARCH

Not Applicable.

### RELATED APPLICATIONS

This application is a continuation-in-part of U.S. patent application Ser. No. 11/376,721, filed on Mar. 15, 2006, which claims priority to U.S. Provisional Patent Application Ser. No. 60/673,212, filed on Apr. 20, 2005, and U.S. Provisional Patent Application Ser. No. 60/717,343, filed on Sep. 15, 2005, and this application claims priority to U.S. Provisional Patent Application Ser. No. 60/778,031, filed on Mar. 1, 2006. The entirety of each of these applications is incorporated herein in their entirety.

### FIELD OF INVENTION

This invention relates to devices for moving an object by pulling on a tensioning member to which the object is attached. More particularly, the invention relates to a device that couples to a rotational power source in order to lift or pull heavy objects by pulling on a rope or cable.

### BACKGROUND OF THE INVENTION

Winches are typically used to lift heavy loads or pull loads across horizontal obstacles. Winches are either motor-driven or hand powered and utilize a drum around which a wire rope (i.e. metal cable) or chain is wound. Manually lifting or pulling heavy objects is not a viable option due to the strength required to lift or pull such objects. Often, fatigue and injury result from manually lifting or pulling such objects. This is why winches are used; they possess massive pulling and towing capabilities, and can serve well for handling heavy objects.

However, winches are limited in their usefulness for several reasons. First, the cable or rope is fixed permanently to the drum, which limits the maximum pull distance and restricts the towing medium to only that rope or cable. Second, the winch must be permanently or semi-permanently fixed to a solid structure to be used, limiting its placement and usability. Third, controlled release of tension is not a capability of many winches, further limiting usability.

As such, there is a need in the art for a versatile, portable, low cost, and easy to use device capable of lifting or pulling a load a desired distance and/or height.

### SUMMARY OF THE INVENTION

The presently disclosed embodiments provide devices capable of lifting or pulling an object (e.g., a person) up or along a tensioning member (e.g., a rope). More specifically, the device is capable of mating to any location of the tensioning member thereby eliminating the need to thread an end of the tensioning member through the device, and the device is further capable of being powered by a rotational power source (portable or fixed) such as a mechanical drill. The use of such a convenient and low-cost power source allows for an economic, simple to use, and easy to carry, portable device capable of lifting and/or pulling heavy loads. Various aspects of the device are disclosed below.

In one aspect, the device includes an input for rotational power wherein the input includes an interface capable of removably engaging a rotational power source. The rotational power source can be any device (portable or fixed) capable of supplying a rotational power to the device. For example, the rotational power source can include a mechanical power drill, a hand crank, an air wrench, or any device having a mechanically powered rotating shaft. Additionally, the device can include a physical attachment capable of attaching the device to the rotational power source.

The device can further include a rope pulling mechanism which includes at least one rotating drum (or a plurality of rotating drums) having a longitudinal axis and a circumference, and a guide mechanism configured to receive a tensioning member (e.g., a rope). The guide mechanism can be further configured to guide the tensioning member onto, around at least a portion of the circumference of, and off of the rotating drum as the drum rotates. In one embodiment, the longitudinal axis of the rotating drum is parallel with a longitudinal axis of the tensioning member thereby allowing the drum to act, in general, as a capstan. In another embodiment, a plurality of rotating drums can be utilized wherein the longitudinal axis of each drum is substantially perpendicular to the longitudinal axis of the tensioning member thereby allowing the drums to act, in general, as a pulley system. In an exemplary embodiment, an outer surface of the rotating drum has a surface characterized by a anisotropic friction.

In any of these embodiments, the rotating drum(s) can be configured to receive an output (i.e., a rotating force) from an engaged rotational power source capable of rotating the drum at a desired speed. In response to the output of the rotational power source, the rotating drum can continuously pull the tensioning member through the device. The device can couple the rotating drum to the output of the rotational power source via a gear box, or the rotating drum can be coupled directly to the rotational power source.

The device can include various safety features capable of locking the device at a desired position along the length of the tensioning member. For example, the device can include a gearbox having a worm gear, and/or the device can include a cam-lock positioned at various locations of the device and in communication with the tensioning member.

Additionally, the device can further include an attachment point capable of attaching an object to the device. For example, the object can be a person (in the case of lifting a person along a length of the tensioning member), or the object can be a non-movable object (such as in the case of utilizing the device as a portable winch).

In another aspect, the device can include a rope pulling mechanism including a rotating drum wherein the rope pulling mechanism can be coupled to a tensioning member at any position along a length of the tensioning member thereby eliminating the need to thread an end of the tensioning member through the device. Further, the device can include an input for rotational power which includes an interface capable of removably engaging a rotational power source. The input can further be configured to couple an output of the rotational power source (i.e., a rotational power) to the rope pulling mechanism thereby enabling the device to apply a tension to the tensioning member in response to an output from the rotational power source.

These aspects and others will be discussed in detail below.

### BRIEF DESCRIPTION OF THE DRAWINGS

The following figures provide illustrative examples of various embodiments of the present invention. The figures are not meant in any way to limit the scope of any embodiment of the presently disclosed devices, systems or methods of use.

FIG. 1 is a diagrammatic view of an exemplary embodiment of the presently disclosed device;

FIG. 2 is a diagrammatic view of an alternative embodiment of the presently disclosed device;

FIG. 3 is a diagrammatic side view of an exemplary embodiment of the presently disclosed device;

FIG. 4 is a diagrammatic side view of an alternative embodiment of the presently disclosed device;

FIG. 5 is a view of an exemplary embodiment of a rope-pulling mechanism of the presently disclosed device;

FIG. 6A is a view of an exemplary embodiment of a rotating drum of the rope pulling mechanism of FIG. 5;

FIG. 6B is a top view of the embodiment of FIG. 6A;

FIG. 7 is an embodiment of a rope pulling mechanism of the presently disclosed device; and

FIG. 8 is a representation of showing a rotational power source disengaged from the presently disclosed device.

### DETAILED DESCRIPTION

The presently disclosed embodiments provide devices capable of lifting or pulling an object (e.g., a person) up or along a tensioning member (e.g., a rope). More specifically, the device is capable of mating to any location of any type of tensioning member (e.g., various types, various lengths, various diameters, etc.), and subsequently being interfaced with and powered by a rotational power source (such a mechanical drill). The use of such a rotational power source allows for a low cost, simple to use, easy to carry device capable of lifting and/or pulling heavy objects. In use, the device can be clipped to either a climbing harness or Swiss seat, or can be attached to a grounded object to act as a winch.

As will be discussed in detail below, the device can provide a smooth, controlled, continuous pull while raising (or lowering) an object (e.g., person). Further, the device can be easy and intuitive to use by minimally trained or untrained personnel. In order to perform various functions, the device can apply its pulling force both at high force levels, for portable winching applications, or at fast rates, for rapid vertical ascents. As a safety feature, the device can include a safety lock mechanism that prevents unwanted reverse motion of the rope or cable. These and other aspects of the presently disclosed device will be discussed in detail below.

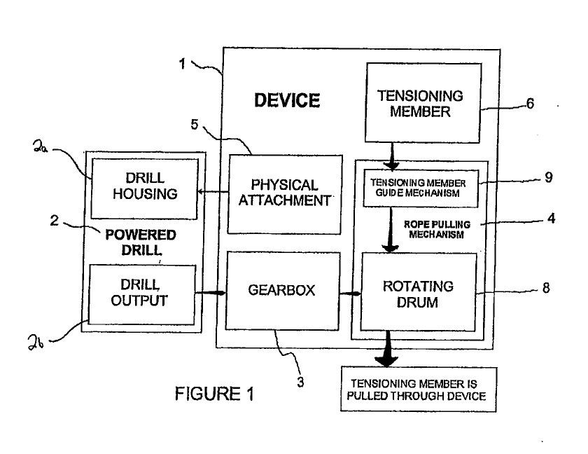

FIG. 1 diagrammatically illustrates an exemplary embodiment of the presently disclosed device 1. As shown, a rotational power source (e.g., a power drill) 2 can interface with the device 1. The rotational power source 2 can be a portable device or a fixed device. Typically, the rotational power source 2 can include a housing 2a and a drill output 2b. In an exemplary embodiment, the rotational power source is a mechanical drill. The ability to interface a low cost, every day power drill 2 to the device 1 can provide significant cost savings and simplicity to use of the device 1.

Depending on the rotational power source 2 used to power the system, different pulling rates and load capabilities can be achieved. Also, as will be discussed below, adjusting components of the gearbox 3 can produce a desired pulling force. Exemplary embodiments of the rotational power source 2 include a DeWalt 36V cordless hammer drill, p/n DC900KL, the DeWalt 36V cordless rotary hammer, p/n DC232KL, or the DeWalt 36V cordless impact wrench, p/n DC800KL, all as powered by 36V high-power Lithium Ion battery packs, manufactured by A123 Systems, Inc, of Watertown, Mass. The extremely high power to weight ratio (3000 W/kg) of these battery packs makes the DeWalt 36V cordless tools allows for high loads and high pulling rates, and allows for maximum versatility as a cordless power tool. In alternative embodiments, the rotational power source 2 can include the 24V Panasonic cordless rotary hammer, p/n EY6813NQKW, or other 28V, 24V, 18V, 14.4V or 12V cordless drill systems. Those skilled in the art will appreciate that various other power drills are within the spirit and scope of the present invention.

Various other types of rotational power sources 2 can be utilized by the presently disclosed device. For example, the rotational power source 2 can be a hand crank, an air wrench, rotary saw, rotary hammer, or any device having a rotating shaft. As will be appreciated by those skilled in the art, various other rotational power sources are within the spirit and scope of the present invention.

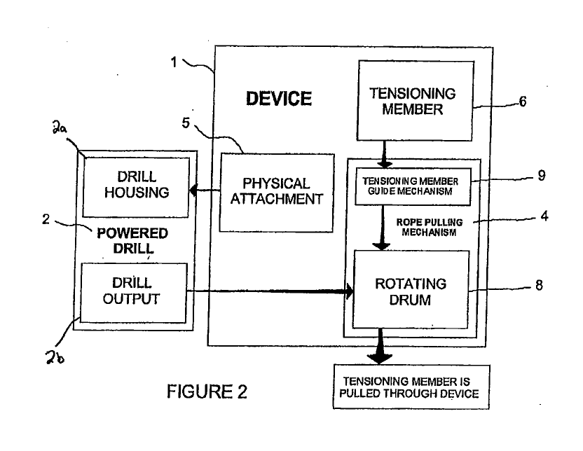

The output of the rotational power source 2 can be coupled to a rotating drum 8 of the device 1. The output of the rotational power source 2 is the rotating shaft of the rotating power source 2. As such, coupling the output of the rotational power source to the rotating drum provides a rotating force to the rotating drum. FIG. 1 illustrates an exemplary embodiment wherein the output is coupled to the rotating drum via a gear box 3. As will be appreciated by those skilled in the art, the gears of the gearbox 3 can be selected in order to provided a desired force from the rotational power source 2 to the rotating drums 8 (and ultimately to the tensioning member 6). The rotational coupling between the rotational power source 2 and the gearbox 3 can be accomplished via the chuck of the rotational power source 2, or by various other means known in the art. In an alternative embodiment, as shown in FIG. 2, the rotational power source 2 can be coupled directly to the rotating drum(s) 8 thereby eliminating the need for the gear box 3. Such coupling can be achieved via a drill chuck or as otherwise known in the art. Those skilled in the art will appreciate that the rotating drum(s) 8 of the device 1 can be mated to the output of the rotational power source 2 in a variety of manners and remain within the spirit and scope of the present invention.

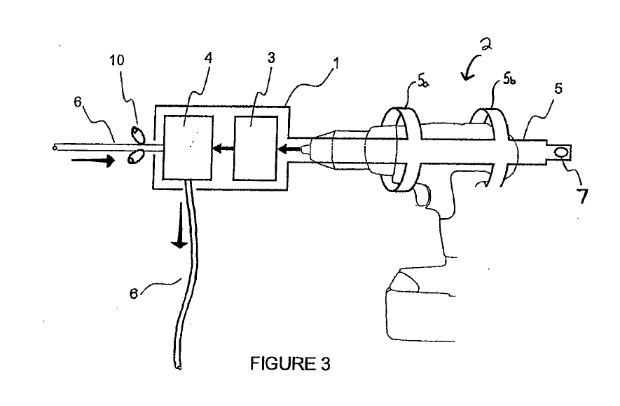

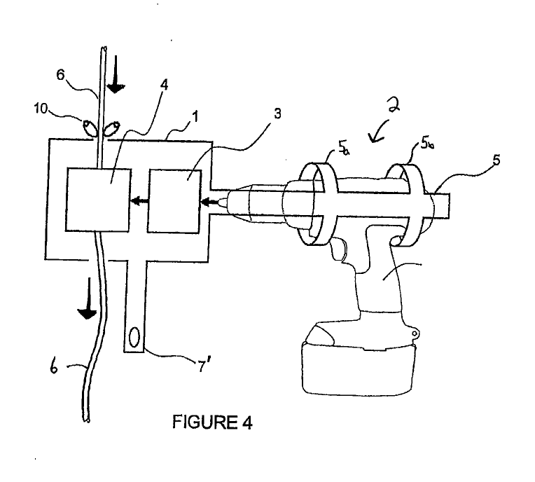

Next, FIG. 1 illustrates that the rotational power source 2 additionally includes a physical attachment 5 to the device 1. The physical attachment 5 allows the rotational power source 2 to apply a directional torque to the rope pulling mechanism 4 with respect to the body of the rotational power source 2. Further, the physical attachment 5 allows for added stability and safety in order to ensure that the rotational power source 2 does not detach from the device while in use. As will be apparent to those skilled in the art, the physical attachment 5 can include various forms. For example, the physical attachment 5 can include a direct attachment of a drill chuck (not shown) of the rotational power source 2 to the device 1. Further, the rotational power source 2 can include an extension (not shown) which can be received in a “key-hole” element (not shown) of the device 1 so as to lock the device 1 to the rotational power source. In one example, clearly shown in FIGS. 3 and 4, the physical attachment 5 can include a first circular element 5a and a second circular element 5b capable of encircling portions of the rotational power source 2 so as to maintain the rotational power source 2 in communication with the device 1. As will be apparent to those skilled in the art, the physical attachment 5 of the device 1 to the rotational power source 2 can be accomplished in a wide variety of manners.

FIG. 1 further diagrams the tensioning member 6 being acted upon by the device 1. The tensioning member 6 can include any elongate resilient element capable of withstand a tension. For example, the tensioning member 6 can include strings, ropes, cables, threads, fibers, filaments, etc. Furthermore, the tensioning member 6 can be of any diameter and/or length. Those skilled in the art will appreciate that various examples of such tensioning members 6 are within the spirit and scope of the present invention.

As shown in FIGS. 1 and 2, the device 1 can include a tensioning member guide mechanism 9 which allows for proper positioning of the tensioning member 6 on the rotating drum(s). Once properly positioned, a rope pulling mechanism 4 can be activated by the rotational power source 2 to provide a controlled and continuous force on the tensioning member 6 thereby allowing for a object attached to the tensioning member 6 or, alternatively, an object (e.g., a person) attached to the device to be raised or pulled a desired distance. As will be discussed below, an advantage of the presently disclosed device is that the rope pulling mechanism 4 (including the guide mechanism 9 and rotating drum(s) 8) can be mated to any location of the tensioning member 6. As such, the present device 1 eliminates the need to thread an end of the tensioning member 6 into the device prior to use.

FIG. 3 illustrates an exemplary embodiment of the device 1 in use. As shown (see arrows), the tensioning element 6 can enter the device 1 and be guided into a rope pulling mechanism 4. The rope pulling mechanism 4 comprises a tensioning member guide mechanism 9 (as diagrammed in FIGS. 1 and 2) and at least one rotating drum 8 wherein the guide member 9 can properly position the tensioning member 6 onto the rotating drum(s). Next, the device can include an attachment point 7 capable of anchoring the device to a grounded body (e.g., a load when pulling a load up the tensioning member, or a stable body when acting as a portable winch). This attachment point 7 can allow all tension imposed by the rope pulling mechanism 4 on the tensioning member 6 to be relayed to the grounded body through the device 1 itself, rather than through the body of the rotational power source 2. In the embodiment of FIG. 3, the attachment point 7 can be positioned collinear with the tensioning element 6 and with the longitudinal axis of the output of the rotational power source 2 so as to increase the ease of use and ergonomics of the device 1. In such an embodiment, when the tensioning member 6 is under tension, the system, comprising the device 1 and rotational power source 2, will be suspended in a neutrally stable orientation between the distal end of the tensioning element 6 and the attachment point 7.

Looking in more detail at FIG. 3, the elongate tensioning member 6 enters the device 1 horizontally, in accordance with the primary longitudinal axis of the drive of the device 1, the device comprising the rope pulling mechanism 4 and gearbox 3 (optional). The device can be further capable of receiving and mating to the rotational power source 2. Once the tensioning member is positioned and the rotational power source 2 activated, the tensioning member 6 can be pulled into the device 1 as indicated by the directional arrow. The tensioning member 6 exits the device 1 via the rope pulling mechanism 4 in a vertical orientation. As indicated, the tensioning member 6 is free of any additional imposed tension as the member 6 leaves the device 1. Tension in the tensioning member 6 is relayed to ground via the attachment point 7. In this embodiment, the device 1 and rotational power source 2 can rest in a neutrally stable orientation, suspended between the tensioning member 6 and the attachment point 7.

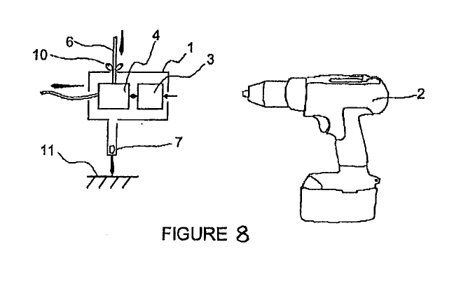

The device can additionally include various safety features capable of preventing the device from unwanted backward motion relative to the tensioning member 6. For example, the gearbox 3 can include a worm gear. As will be appreciated by those skilled in the art, if the gearbox 3 includes a worm gear on the input side which is coupled to a spur or other gear as part or all of the output side of the gearbox 3, the device 1 will not be back-drivable, meaning the rope pulling mechanism 4 will remain locked to all imposed tension in the system even if the rotational power source 2 is removed. As will be discussed in relation to FIG. 8, the capability to disengage the rotational power source 2 from the device 1 while leaving the device 1 under tension enables multiple devices 1 to be utilized in tandem, all powered by moving the rotational power source 2 from device to device, increasing the tension in each respective tensioning member 6 along the way.

As a further safety feature, equal facility for locking the device 1 against back-tension may be enabled by placing a frictional cam-lock 10 where the tensioning member 6 enters the device 1. This cam-lock 10 utilizes self-help to increase gripping force against the tensioning member 6 in response to increased tension, thereby locking the tensioning member 6 against movement out of the device 1, and allowing movement into the device 1 as depicted by the arrow. As will be appreciated by those skilled in the art, the cam-lock 10 can also be placed at different locations in the device 1, such as after the rope pulling mechanism 4, with the same functionality being enabled. Furthermore, those skilled in the art will appreciate that various other safety/locking devices can be incorporated in the device 1 while remaining within the spirit and scope of the present invention.

FIG. 4 depicts an alternative embodiment of the device with a rearranged component configuration. As shown, the tensioning member 6 can enter the device 1 vertically, in accordance with the directional arrow. The tensioning member 6 then can exit the rope pulling mechanism 4 and device 1 vertically and without tension, in accordance with the second directional arrow. Tensile force imposed by the rope pulling mechanism 4 on the tensioning member 6 can be relayed through the device 1 to the attachment point 7′ which can provide an anchor to a grounded body, and which may be oriented collinear with the taut side of the tensioning element 6, to allow the device 1 and rotational power source 2 to rest in a more usable neutral orientation during use.

As described above, the rope pulling mechanism 4 of the device 1 is capable of engaging and pulling the tensioning member 6 through the device. Various exemplary embodiments of the rope pulling mechanism 4 are described in U.S. Provisional Patent Application 60/717,343, filed September 2005, entitled “Powered Rope Ascender and Portable Rope Pulling Device,” and U.S. patent application Ser. No. 11/376,721, filed Mar. 15, 2006, entitled “Powered Rope Ascender and Portable Rope Pulling Device,” which are expressly incorporated herein by reference.

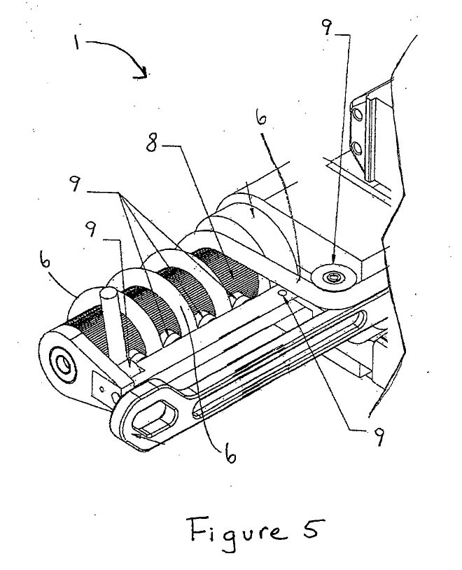

FIG. 5 is a view of the distal end of the device 1 utilizing an exemplary embodiment of the rope pulling mechanism as disclosed in the above-identified incorporated applications. As shown, the rope pulling mechanism includes a rotating drum 8 and a guide mechanism 9. The rotating drum 8 includes a longitudinal axis and a circumference wherein the longitudinal axis is positioned substantially parallel to a longitudinal axis of the tensioning member thereby allowing the drum 8 to act, in general, as a capstan. Further, the guide member 9 is configured to receive the tensioning member 6, and further configured to guide the tensioning member 6 onto, around at least a portion of the circumference of, and off of the rotating drum 8.

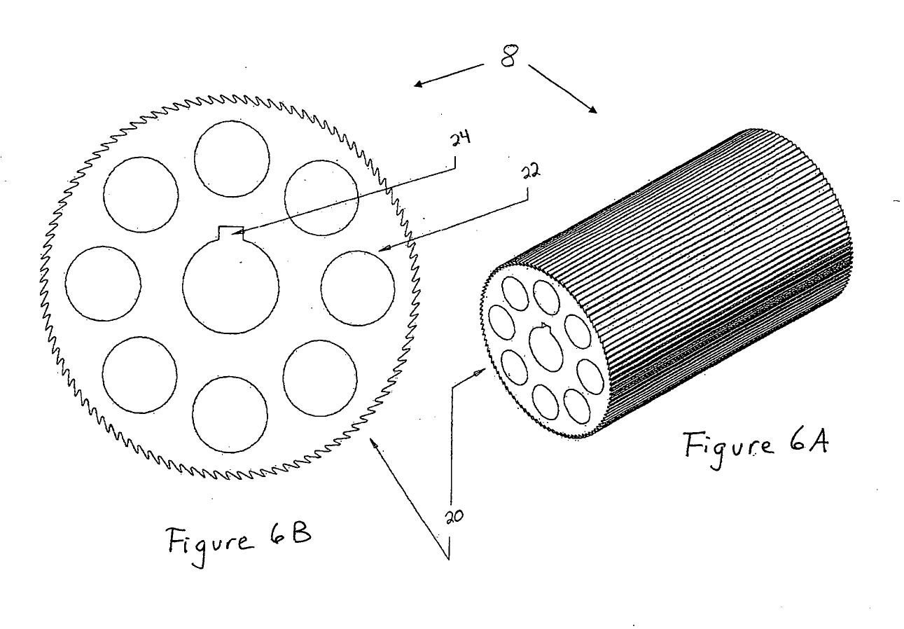

FIGS. 6A and 6B show views of an exemplary embodiment of the rotating drum. In this embodiment, the operation of a rope pulling device 1 can be aided by designing the surface of the rotating drum 8 to have anisotropic friction properties. In particular, the drum can be designed to have a high friction coefficient in a direction substantially about its circumference and a lower friction coefficient in a substantially longitudinal direction. In an exemplary embodiment, the rotating drum is a cylinder; however, as will be apparent to those skilled in the art, various other shapes can be used and are meant to be encompassed by the word “drum”. As shown in FIG. 6A, the surface of the drum 8 can include longitudinal splines to create this anisotropic friction effect. In this embodiment, a cylinder, preferably constructed of aluminum or another lightweight metal or material, is extruded to include the illustrated longitudinal splines. More specifically, as clearly shown in FIG. 6B, the rotating drum 8 can include longitudinal shaped-shaped splines 20 and a hole for a shaft with a keyway cutout 24. Forming the longitudinal splines as shaped features angled into the direction of motion of the rotating drum 8 further enhances the friction between the rope and the drum. Additionally, various weight-reducing holes 22 can also be utilized to minimize weight of the entire device.

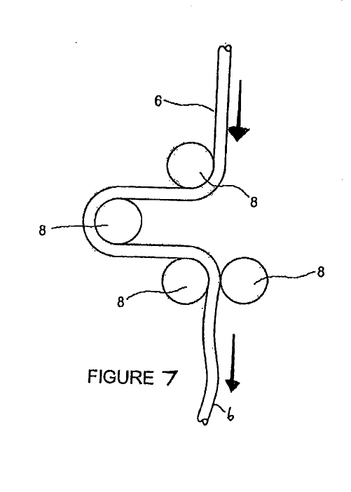

FIG. 7 shows an alternative embodiment wherein the rope pulling mechanism 4 can include a plurality of rotating drums 8, generally acting in the manner of pulleys, which interact with the tensioning member 6 to pull the tensioning member 6 through the device 1. As shown, the longitudinal axis of the rotating drums 8 are positioned substantially perpendicular to the longitudinal axis of the tensioning member 6. In this embodiment, the output of the gearbox 3 is coupled rotationally to at least one of the rotating drums 8. When an initial tension is imposed on the tensioning member 6, either by the working load or by the rope pulling mechanism 4, a partial or full wrap of the tensioning member 6 around each drum 8 provides an amplified tensile force due to the capstan effect, and thereby increases the frictional force between the rotating drums 8 and the tensioning member 6. Alternatively, the output of the drill 2 can be rotationally coupled directly to one or more of the rotating drums 8 without going through an additional gearbox 3.

As will be appreciated by those skilled in the art, the various embodiments of the device can allow for a variety of uses. For example, in one embodiment, the object can be attached to the distal end of the tensioning element 6 with the attachment point 7 of the device 1 anchored to a grounded point, thus pulling the object toward the stationary device 1. In an alternative embodiment, the object can be connected to the attachment point 7 of the device 1, with the distal end of the tensioning element 6 being fixed to a grounded point, in operation thereby pulling the device 1 and its load along the tensioning element 6 toward the fixed distal end. As such, the device 1 and rotational power source 2 can be suspended in a stable orientation between the distal end of the tensioning element 6 and the attachment point 7, regardless of the relative orientation of those two points. This allows loads to be pulled horizontally, vertically, or at any angle in between, with the weight of the rotational power source 2 imposing minimal off-axis moments to the tensioning element 6, and thereby positioning the device 1 and rotational power source 2 suspended in an orientation of higher ergonomic usability to the operator.

As briefly mentioned above, while in use, the device 1 can be disengaged from the rotational power source 2 while keeping a desired tension on the tensioning member 6. FIG. 8 shows such an embodiment wherein the tension between the tensioning member 6 and the ground 11 can be maintained due to the restriction of backward motion of the tensioning member 6 by either a cam-lock 10 or by a non-backdrivable gearbox 3 (each discussed above). The functionality enabled by this configuration is such that multiple devices 1 can be used in tandem with the same rotational power source 2 moving between devices 1 to increase tension sequentially in multiple tensioning members 6, such as in tent guys, or truck tie-downs.

A person of ordinary skill in the art will recognize that the configurations described above are not the only configurations that can employ the principles of the invention. The system and method described above, utilizing a rope pulling mechanism comprising a rotating drum and a rope guide mechanism, powered by a rotational power source such as a motorized drill or other rotational device, can be practically employed in various other configurations. As such, any configuration or placement of all the parts, rotational power source, gearbox, and rotating drum/guide assembly with relation to one another could be deployed by a person of ordinary skill in keeping with the principles of the invention. Additionally, various components can be added or subtracted to the device and/or system while remaining within the spirit and scope of the present invention.

The lifting and pulling of heavy objects is a wide-ranging task inherent in many endeavors, commercial, domestic, military, and recreational. The presently disclosed device, a portable rope pulling and climbing device, can solve many problems associated with using current lifting and pulling technology, including but not limited to: accommodating multiple types and diameters of flexible tensioning members, being able to attach to the flexible tensioning member without threading a free end through the device, and being capable of providing a smooth continuous pull. Furthermore, the presently disclosed embodiments provide a device which itself can travel up or along a rope, provide a device which is easy and intuitive to use, provide a device which can let out or descend a taut flexible tensioning member at a controlled rate with a range of loads, and further, provide a device and method that is usable in and useful for recreation, industry, emergency, rescue, manufacturing, military, and other applications.

A person of ordinary skill in the art will appreciate further features and advantages of the presently disclosed device based on the above-described embodiments. For example, specific features from any of the embodiments described above as well as those known in the art can be incorporated into the presently disclosed embodiments in a variety of combinations and subcombinations. Accordingly, the presently disclosed embodiments are not to be limited by what has been particularly shown and described. Any publications and references cited herein are expressly incorporated herein by reference in their entirety.

1. A device for pulling a tensioning member, comprising:
an input for rotational power, the input comprising an interface capable of removably engaging a rotational power source;
a rotating drum configured to receive an output from an engaged rotational power source, the rotating drum having a longitudinal axis and a circumference; and
a guide mechanism configured to receive a tensioning member, the guide mechanism further configured to guide the tensioning member onto, around at least a portion of the circumference of, and off of the rotating drum,
wherein the rotating drum continuously pulls the tensioning member through the device in response to an output supplied by an engaged rotational power source.

2. The device of claim 1, wherein the rotational power source is a portable mechanical drill.

3. The device of claim 1, wherein the rotational power source is a hand crank.

4. The device of claim 1, wherein the rotational power source is an air wrench.

5. The device of claim 1, wherein the rotational power source is a device having a powered rotational shaft.

6. The device of claim 1, further comprising a physical attachment for attaching the device to the rotational power source.

7. The device of claim 1, wherein a gearbox couples the rotating drum to an output of an engaged rotational power source.

8. The device of claim 7, wherein the gearbox includes a worm gear capable of locking the device at a desired position along a length of the tensioning member.

9. The device of claim 1, further comprising a cam-lock capable of locking the device at a desired position along a length of the tensioning member.

10. The device of claim 1, wherein an outer surface of the rotating drum has a surface characterized by a anisotropic friction.

11. The device of claim 1, further comprising an attachment point capable of attaching an object.

12. The device of claim 11, wherein the object is a person.

13. The device of claim 11, wherein the object is a non-movable object.

14. The device of claim 13, wherein the device is configured to be a portable winch.

15. A device for lifting a load, comprising:
a rope pulling mechanism comprising a rotating drum, the rope pulling mechanism capable of being coupled to a tensioning member at any position along a length of the tensioning member, the rope pulling mechanism further comprising a guide mechanism configured to receive the tensioning member, the guide mechanism further configured to guide the tensioning member onto, around at least a portion of a circumference of the rotating drum, and off of the rotating drum; and
an input for rotational power, the input comprising an interface capable of removably engaging a rotational power source, the input configured to couple an output of the rotational power source to the rotating drum, the rotating drum capable of continuously pulling the tensioning member through the device in response to an output of the rotational power source.

16. The device of claim 15, wherein the rotational power source is a portable power drill.

17. The device of claim 16, further comprising an attachment point capable of attaching to an object.

18. The device of claim 17, wherein the object is a person.

19. A device for pulling a tensioning member, comprising:
an input for rotational power, the input comprising an interface capable of removably engaging a rotational power source;
a plurality of rotating drums configured to receive an output from an engaged rotational power source, the rotating drums each having a longitudinal axis and a circumference; and
a guide mechanism configured to receive a tensioning member, the guide mechanism further configured to guide the tensioning member onto, around at least a portion of the circumference of the rotating drums, and off of the rotating drums,
wherein the rotating drums continuously pull the tensioning member through the device in response to an output supplied by an engaged rotational power source, the longitudinal axis of each rotating drum being substantially perpendicular to a longitudinal axis of the tensioning member.

20. The device of claim 19, wherein the rotational power source is a portable mechanical drill.
